(19) United States
(12) Patent Application Publication
(10) Pub. No.: US 2010/0253777 A1
(43) Pub. Date: Oct. 7, 2010

(54) VIDEO MONITORING SYSTEM, IMAGE ENCODER AND ENCODING METHOD THEREOF

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/435,365

(22) Filed: May 4, 2009

(30) Foreign Application Priority Data
Apr. 3, 2009 (CN) 200910301342.6

(51) Int. Cl. H04N 7/18; H04N 7/26

(52) U.S. Cl. 348/143; 375/240.08; 375/E07.026; 348/E07.085

(57) ABSTRACT

A video monitoring system includes a camera, an image encoder, and a recording unit. The camera captures a plurality of images of an object to be watched. The image encoder detects the plurality of images to determine key portions of each image, compresses data of portions of each image other than the key portions. The recording unit records the plurality of images from the compressing module to make sure the images displayed have high definition of the key portions.

### BACKGROUND

1. Technical Field

The present disclosure relates to a video monitoring system, an image encoder of the video monitoring system, and an encoding method of the image encoder.

2. Description of Related Art

Video monitoring (or surveillance) systems have been used in many fields, such as traffic control, security. Currently, before the video monitoring systems record the video, an image encoder compressed data of the video from a camera. As a result, after the data of the video is compressed, the video displayed on a monitor may have low definition, and key portions of an object to be watched blurry.

### BRIEF DESCRIPTION OF THE DRAWINGS

FIG. 1 is a schematic diagram of an exemplary embodiment of a video monitoring system.

FIG. 2 is a flowchart of an exemplary embodiment of a encoding method used for the video monitoring system.

### DETAILED DESCRIPTION

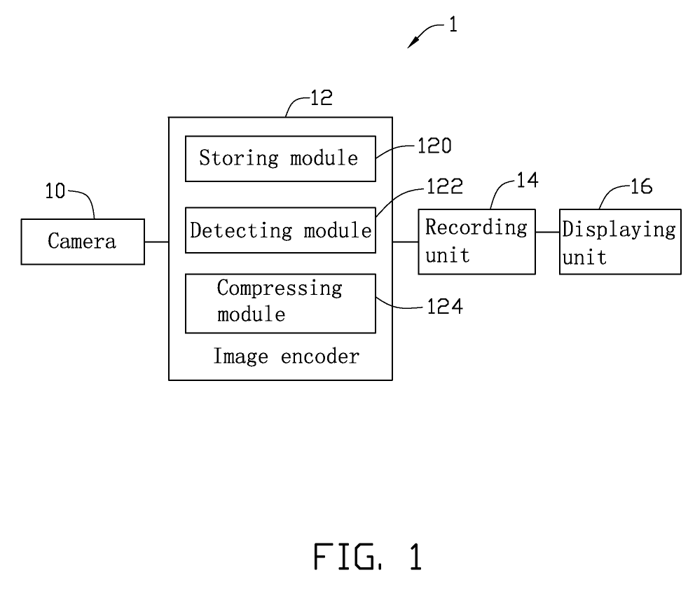

Referring to FIG. 1, an exemplary embodiment of a video monitoring system 1 includes a camera 10, an image encoder 12, a recording unit 14, and a displaying unit 16. The image encoder 12 includes a storing module 120, a detecting module 122, and a compressing module 124.

A plurality of images of an object to be watched which are captured by the camera 10 are transmitted to the storing module 120 of the image encoder 12. The detecting module 122 detects the plurality of images stored in the storing module 120 to get key portions of each image, and coordinates of the key portions in each image. In the embodiment, the object to be watched is a car, and the key portion of the car is a license plate. The coordinates of the key portions of the images are transmitted to the compressing module 124 of the image encoder 12. It can be understood that the detecting module 122 gets key portions of each image with a well known technology.

The compressing module 124 compresses data of the portions of each image other than the key portions. In other words, the compressing module 124 compresses data of portions of each image except that with the coordinates from the detecting module 122.

The compressing module 124 transmits the data of the key portions and the other portions of each image to the recording unit 14. The recording unit 14 records the data. The displaying unit 16 displays the recorded video from the recording unit 14. In the embodiment, the recording unit 14 is a videocassette recorder (VCR), the displaying unit 16 is a monitor, and the storing module 120 is a hard disk.

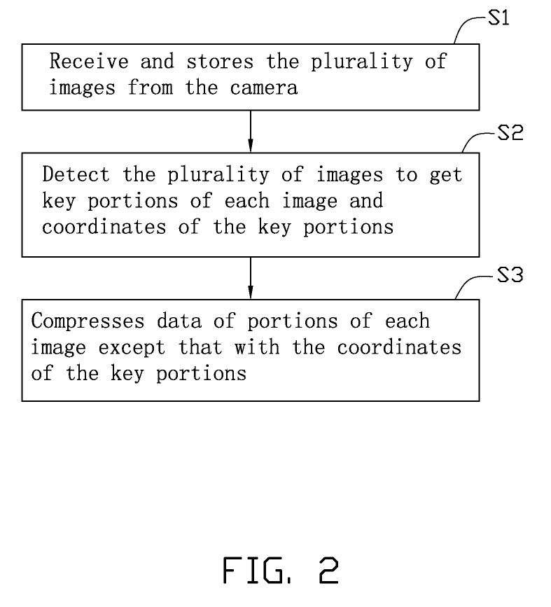

Referring to FIG. 2, an exemplary embodiment of an encoding method using the above-mentioned image encoder 12 includes the following steps.

In step S1, the storing module 120 receives and stores the plurality of images from the camera 10.

In step S2, the detecting module 122 detects the plurality of images stored in the storing module 120 to get key portions of each image and coordinates of the key portions.

In step S3, the compressing module 124 compresses data of the portions of each image except that with the coordinates from the detecting module 122

The image encoder 12 detects images of the object to get key portions of each image by the detecting module 122. Data of the key portions of each image is not compressed by the compressing module 124. As a result, the displaying unit 16 can display the key portions of each image of the object with high definition.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A video monitoring system comprising:
a camera to capture a plurality of images of an object to be watched;
an image encoder comprising:
a storing module to store the plurality of images of the object from the camera;
a detecting module to detect the plurality of images stored in the storing module to determine key portions of each image; and
a compressing module to compress data of the portions of each image other than the key portions; and
a recording unit to record the plurality of images from the compressing module.

2. The video monitoring system of claim 1, wherein the detecting module is further operable to determine coordinates of the key portions of each image, the compressing module is operable to compress data of images except that with the coordinates.

3. An image encoder, comprising:
a storing module to store a plurality of images;
a detecting module to detect the plurality of images to determine key portions of each image; and
a compressing module to compress data of the portions of each image other than the key portions.

4. The image encoder of claim 3, wherein the detecting module is further operable to determine coordinates of the key portions of each image, the compressing module is operable to compress data of portions except that with the coordinates.

5. An image encoding method comprising:
storing a plurality of images;
detecting the plurality of images to determine key portions of each image; and
compressing data of each image except that of the key portions.
